(19) United States
(12) Patent Application Publication
(10) Pub. No.: US 2025/0375005 A1
(43) Pub. Date: Dec. 11, 2025

(54) SPECIE NEGOTIABLE INSTRUMENT

(71) Applicant: Lawrence Hilton, Highland, UT (US)

(72) Inventor: Lawrence Hilton, Highland, UT (US)

(21) Appl. No.: 19/085,911

(22) Filed: Mar. 20, 2025

Related U.S. Application Data
(60) Provisional application No. 63/567,869, filed on Mar. 20, 2024.

(51) Int. Cl. A44C 21/00

(52) U.S. Cl. CPC A44C 21/00

(57) ABSTRACT

An enhanced specie negotiable instrument which may be embodied in computer-readable memory in electronic form, exchangeable for physical precious metals. The specie negotiable instrument comprises a legend reading one or more of the following in whole or in part, “exchangeable for money”, “payable on demand”, “unconditional promise”, “to pay a fixed amount of money to the bearer, “legal tender to bearer upon demand.”

### BACKGROUND

### Field of the Invention

This invention relates to an exchangeable legal tender, and more particularly relates to specie negotiable instrument embodied in computer-readable memory.

### Description of the Related Art

Throughout history, the clearing of negotiable instruments, such as checks and money orders, has constituted a paper-intensive process. Negotiable instruments such as the dollar bill are bearer currencies, meaning the bearer of the dollar bill or negotiable instrument is the presumed owner.

Bearers may enter a financial institution, such as a bank, and present a negotiable instrument for a particular monetary value to be cashed or deposited. The bank or financial institution may then credit an account of the customer or convert the negotiable instrument into other forms of currency.

In the case of checks, the bank sends the negotiable instrument to a clearinghouse (alternatively referred to as their check processor). This clearinghouse may then route the negotiable instrument to second clearinghouse associated with the issuing bank. This second clearinghouse may process and verify the negotiable instrument. Thereafter, the clearinghouse may transmit or send funds to the bank deposit for the value of the negotiable instrument.

Although negotiable instruments, such as dollars, have value imparted to them by the demand of consumers and bearers within a larger economy for them, the physical components of the dollar bill have no inherent value, typically largely comprising only paper, linen and ink.

In the past, the value of the dollar was directly tied to the value of gold, which has had ubiquitous value throughout history (along with various other precious metals). Due to fluctuations in value of the dollar experienced in relation to the world market and the need to protect the United States gold reserves, the Gold Standard was suspended and reinstated several times until it was finally removed in 1963. In that year, the United States resolved the situation by following the example of most other nations and changing their currency system. Instead of backing the dollar with gold or other precious metals held in reserve, U.S. money became a fiat currency, which is not directly backed by any physical commodity.

As such, in the case of collapse of the U.S. dollar because of hyper-inflation or the collapse of the U.S. economy in situations like war, the physical dollars bills would have no inherent value.

There is a need in the art for a specie negotiable instrument written on computer-readable memory, which has inherent value is exchangeable for precious metals. In view of the foregoing, it is clear that such a negotiable instrument would be desirable.

### SUMMARY

From the foregoing discussion, it should be apparent that a need exists for a system and method for creation of a physical negotiable instrument. The present invention has been developed in response to the present state of the art, and in particular, in response to the problems and needs in the art that have not yet been fully solved by currently available models. Accordingly, the present invention has been developed to provide a specie negotiable instrument comprising: a flexible backing material; a plurality of markings layered upon the flexible backing material, the markings comprising: a predetermined quantity of a precious metal, a serial number, a first denomination indicator indicating a total predetermined weight of a first precious metal incorporated into the markings, a precious metal identifier, a seal indicating a source of origin of the physical negotiable instrument.

In various embodiments, the specie negotiable instrument comprising a legend reading one or more of the following in whole or in part, “exchangeable for money”, “payable on demand”, “unconditional promise”, “to pay a fixed amount of money to the bearer, “legal tender to bearer upon demand.”

The flexible backing material may comprise a foil comprising a precious metal. One or more of the markings layered upon the flexible backing material comprise woven fibers of precious metals. The markings layered upon the flexible backing material may be bonded thereto. The flexible backing material may comprise a polymeric sheet.

In some embodiments, the predetermined quantity of precious metal comprises one of the following fractions of a troy ounce: 1/4000, 1/5000, 1/20, 1/40, 1/100, ¼, 1/200, 1/100, 1/10 and ½.

The specie negotiable instrument may further comprise a second denomination indicator indicating a total predetermined weight of a second precious metal incorporated into the markings.

The physical negotiable instrument may be produced for recognition by a government as a legal tender.

Both a reverse surface and an obverse surface of the physical negotiable instrument may be clear-coated with one of a flexible polymeric, silicone or urethane layer, enveloping the markings between clear-coated surfaces.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a forward perspective view illustrating one embodiment of a physical or specie negotiable instrument in accordance with the present invention;

FIG. 2 is a forward perspective view illustrating one embodiment of a physical or specie negotiable instrument in accordance with the present invention;

FIG. 3 is a forward perspective view illustrating one embodiment of a physical or specie negotiable instrument in accordance with the present invention;

FIG. 4 is a flow chart illustrating the steps of a method of creating a physical or specie negotiable instrument in accordance with the present invention;

FIG. 5 is a block diagram illustrating the steps of a method of creating a negotiable instrument in accordance with the present invention;

FIG. 6 is a data entity diagram illustrating a physical or specie negotiable instrument in accordance with the present invention; and

FIG. 7 is a data entity diagram illustrating the steps of a method of creating a physical negotiable instrument in accordance with the present invention.

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

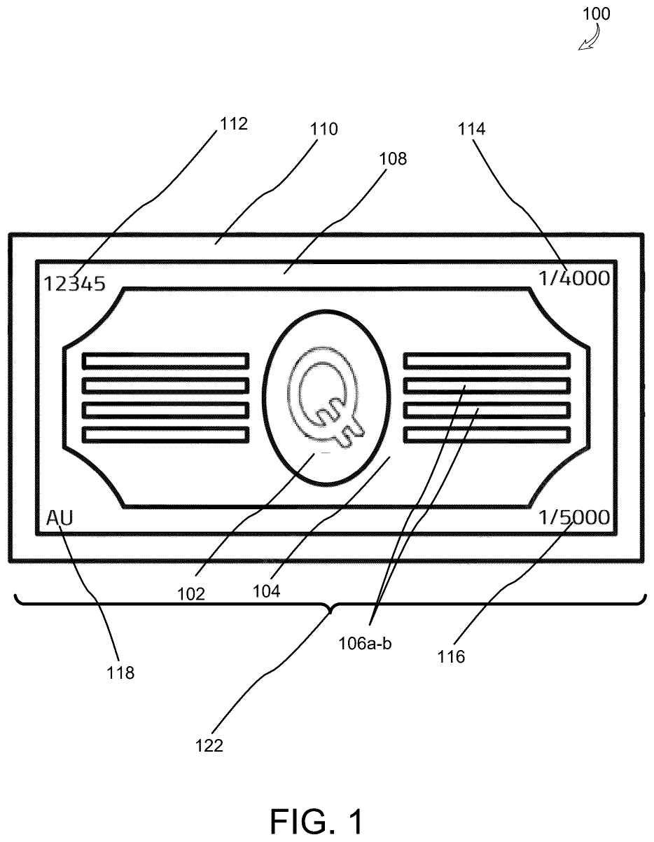

FIG. 1 is a forward perspective view illustrating one embodiment of a physical or specie negotiable instrument 100 in accordance with the present invention.

The physical negotiable instrument 100 may comprise a cut flexible backing material 122 made of polymeric materials and/or paper, linen, or organic materials, shaped to standard geometries such as rectangle, square, ovoid and the like. The backing material 122 may comprise a flexible substrate.

In various embodiments, various markings are printed or inlaid on an obverse or reverse surface of the negotiable instrument 100. By way of example, in various embodiments, these markings including a seal 102, a serial number 112, a first denomination indicator of precious metal quantity 114, a second denomination indicator of precious metal quantity 116, a seal background 104, an inner border 108, an outer border 110, a precious metal identifier 118, and various other markings 106a-b.

The negotiable instrument 100 may be exchanged for U.S. legal tender, such as dollars, but the negotiable instrument 100 has inherent value because it incorporates one or more precious metals.

In various embodiments, the negotiable instrument 100 incorporates gold, silver, platinum, palladium, and the like (“precious metals”). The negotiable instrument 100 may be termed a “goldback” or a “silverback”.

The precious metals may be fused, adhered, plated, laminated or bonded to the backing material 122 using various technologies known to those of skill in the art, including WVPAB (water vapor assisted bonding) or use of amino- and mercaptosilanes to increase adhesion. Methods known in the art may produce layers of precious metal(s) within, or upon, the negotiable instrument 100 having low permeation rates from oxygen and moisture, a smooth uniform surface morphology, and resistance to temperature and chemical reactions. The is particularly important with some precious metals such as silver which are known to oxidize.

The thickness of the layer of precious metals may be between 10 nm and 1 mm. These precious metal layers also improve the optical and aesthetic characteristics of the negotiable instrument 100. The layers of precious metals may comprise foil of precious metal adhered to the backing material 122. In alternative embodiments, the back material 122 is a foil comprising a precious metal and one or more other substances or alloys operable to impart flexibility to the foil as known to those of skill in the art. The backing material 122 may comprise steel, aluminum, titanium, molybdenum and/or copper.

In various embodiments, the layers of precious metals are shaped to produce the markings indicated in FIG. 1. For instance, gold may be layered around the outside perimeter of the negotiable instrument 100 to create the outer border marking 110, or the seal 102 may comprise a precious metal layered upon a preexisting marking such as the seal backing 104.

The layers of precious metals, and the backing material, may be formed from cross-laid, interwoven, or non-woven fibers of precious metals. In various embodiments, the fibers used to create a layer alternate between a fiber made of a precious metal and a polymeric fiber, such as Kevlar, to impart flexibility and strength to the negotiable instrument 100.

The precious metal marking 118 indicates the predominate precious metal within the negotiable instrument 100.

In various embodiments, the layers of precious metals fused to the backing material 122 may be engraved and the marking created through engravature of one or more layers of precious metals.

The first denominated value indicates the quantity of a precious metal incorporated into the negotiable instrument 100. For instance, as shown, the negotiable instrument 100 may incorporate 1/4,000 of a troy ounce of gold. In other embodiments, negotiable instrument 100 incorporates 1/2000, 1/4000, 1/5,000 of a troy ounce of a precious metal. In still further embodiments, the negotiable instrument 100 incorporates 1/200, 1/10, 1/20, 1/40, 1/100, 1/500, 1/333.333, 1/200, or 1/1,000 of an ounce, a troy ounce, pound, gram, grain or kilogram.

The negotiable instrument 100 may be serialized using serial numbers 112.

Both a reverse surface and an obverse surface of the physical negotiable instrument 100 may be sealed or clear-coated with one of a flexible polymeric, silicone or urethane layer, enveloping the markings between clear-coated surfaces.

The negotiable instrument 100 might be produced for recognition by a state as legal tender, for instance pursuant to Article 1, Section 10 of the U.S. Constitution. Various states, such as Utah, also have a specie legal tender acts, including 31 U.S.C. Ann. § 5103, which provides that U.S. coins and currency (including federal reserve notes and circulating notes of federal reserve banks and national banks), are legally authorized. Thus, the negotiable instrument 100 may include the circulating notes of federal reserve banks and national banks.

In various embodiments, the negotiable instrument 100 may be engraved or otherwise marked with the words, “negotiable instrument.”

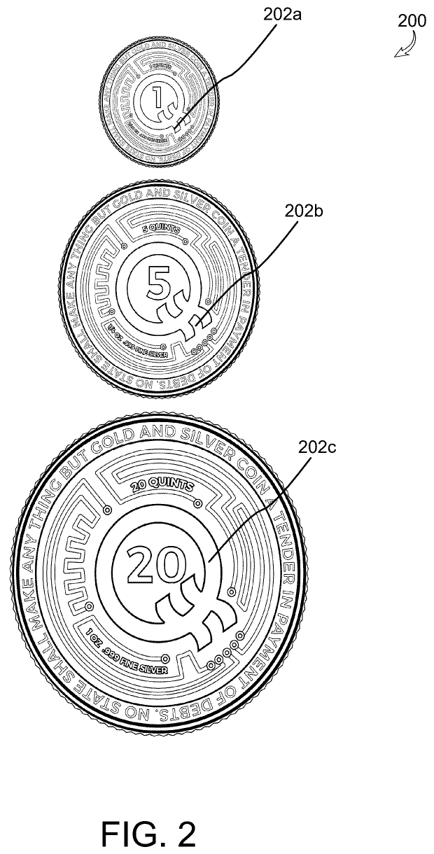

FIG. 2 is a forward perspective view illustrating one embodiment of a physical negotiable instrument 200 in accordance with the present invention.

In various embodiments, the physical negotiable instrument 200 may comprise a coin 202 or token in place of a bill. In various embodiments, the coin 202 may comprise a rigid, cylindrical plate infused with one or more precious metals for recognition as a legal tender.

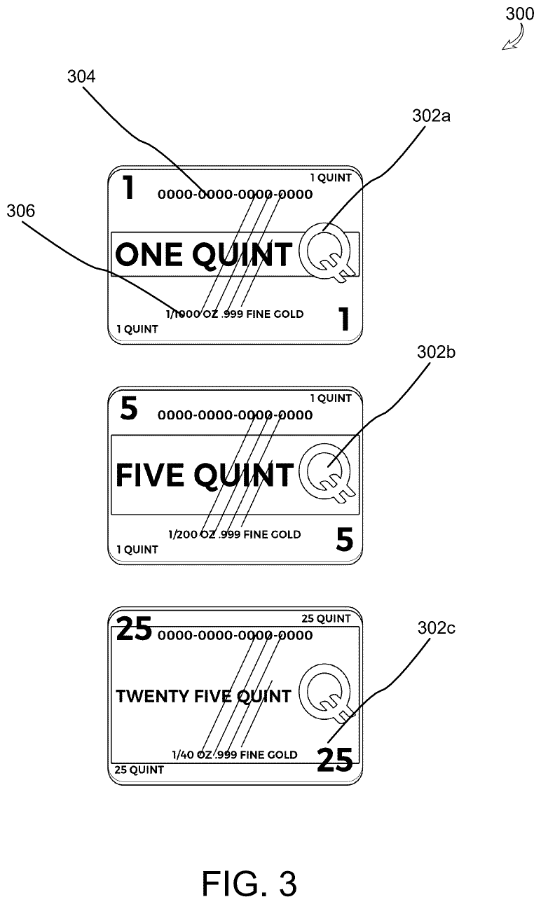

FIG. 3 is a forward perspective view illustrating one embodiment of a specie or physical negotiable instrument 300 in accordance with the present invention.

In various embodiments, the bills 302 are denominated as 1, 5 or 25 “quints”, “goldbacks” or “silverbacks”, but may be otherwise denominated using a brand name. In various embodiments, the bills 302 are serialized with a serial number 304. The amount of precious materials infused into the negotiable instrument 300 may be indicated with inscribed, relief, or printed text 306.

In other embodiments, the specie negotiable instrument comprises a legend reading in whole or in part as follows: “exchangeable for money” and/or “payable on demand” and/or “unconditional promise” and/or “to pay a fixed amount of money to the bearer” and/or “legal tender to bearer upon demand.”

The specie negotiable instrument may be exchangeable for U.S. tender.

The specie negotiable instrument bears an unconditional promise to pay a fixed amount of money to a bearer of the specie negotiable instrument upon demand. This fixed amount of money may be in gold, silver, platinum, other precious metals, or other U.S. tender.

The specie negotiable instrument 300 may be made through a sputtering process in which gold or another precious metal is sputtered onto a polymer. A second layer of polymer may then be laid over the sputtered gold. This process creates a 3D effect in which the sputtered gold appears to be in relief. At an atomic level, atom by atom, the gold is laid down.

Alternatively, the specie negotiable instrument may be printed on a polymer infused with gold.

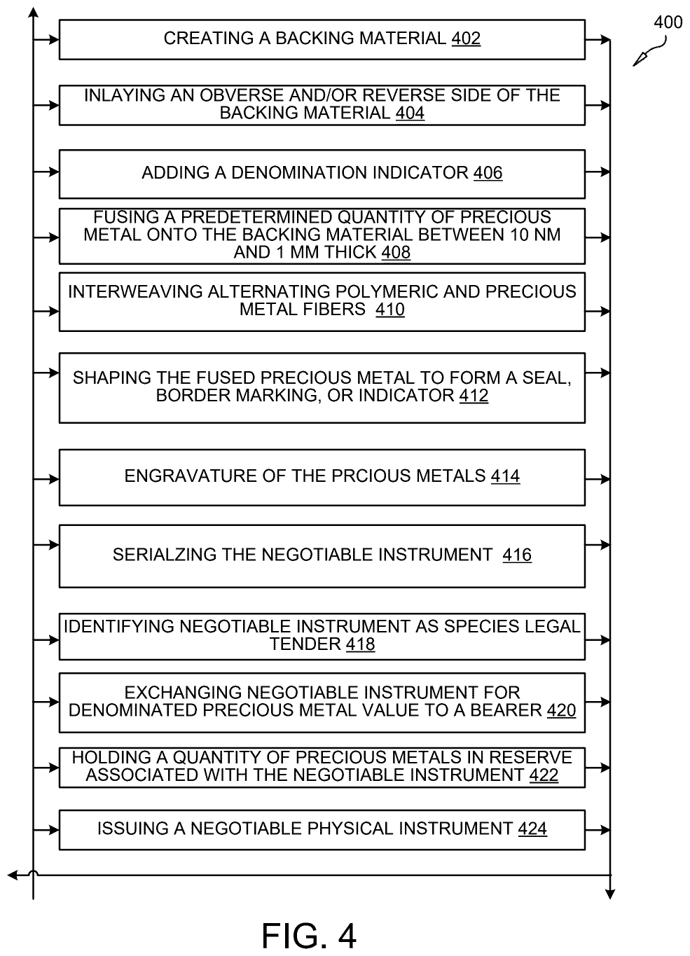

FIG. 4 is a flow chart illustrating the steps of a method 400 of creating a physical negotiable instrument in accordance with the present invention.

In various embodiments, a backing material is created 402 and inlaid 404 on both faces with a precious metal. A denomination indicator may be added 406 to the negotiable instrument which may indicate the density, quantity or quality of one or more precious metals inlaid and/or fused and/or incorporated into the negotiable instrument.

A predetermined quantity of precious metal may be fused 408 into or onto the backing material, which may be between 10 nanometers and 1 or 3 millimeters thick.

In some embodiments, the backing material or material fused onto the backing material, may comprise interwoven 410 fibers to increase flexibility and/or strength of the negotiable instrument. In some embodiments, strands or threads or precious metals or metal alloys are interwoven with polymeric fibers, such as nylon or fiberglass.

The fibers and/or fused materials may be shaped 412 to form a seal on the negotiable instrument. The fibers and/or fused materials may be engraved 414 and the negotiable instrument serialized 416 with a serial number or indicator.

The negotiable instrument may be printed, engraved or otherwise adapted to indicate or identify 418 the negotiable instrument is a specie legal tender.

In some embodiments, including those in which the negotiable instrument is issued in electronic form, a predetermined quantity of precious metals indicated by the denomination indicator may be held 422 physically in reserve in vault or storage area and made available to a bearer upon demand who exchanges 420 the negotiable instrument for the predetermined quantity of precious metal. The negotiable instrument, including embodiments in electronic form, may be formally issued 424 for consideration.

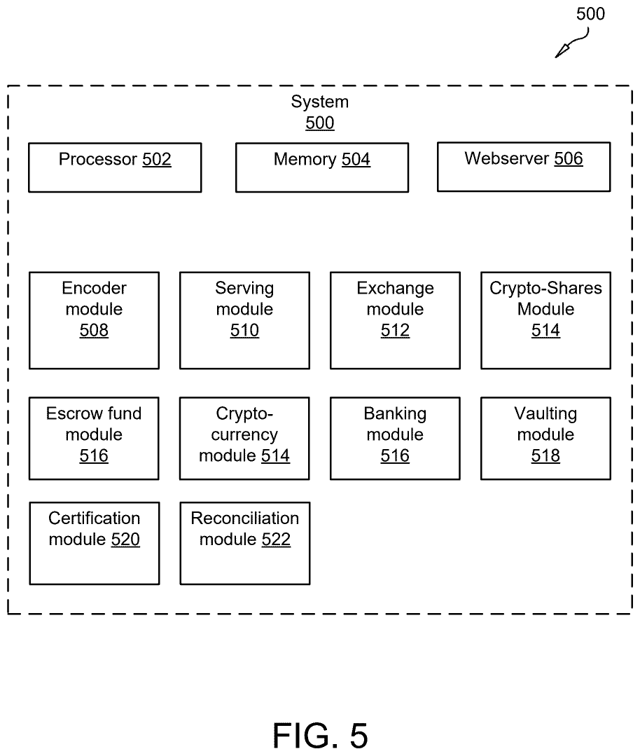

FIG. 5 is a block diagram illustrating the steps of a method 500 of creating a physical negotiable instrument in accordance with the present invention.

Each of the modules 508-522 comprises the front end logic necessary to realize their respective described functions. The system 500 may comprise an application-specific integrated circuit (“ASIC”).

The system 500 may comprise a transmitter and receiver with the logic necessary to receive and transmit bitstreams (i.e. data streams). The system 500 modules may include the software, firmware, and hardware necessary to receive and process SMS messages and media between merchants 104 and members 102, including buffers, data unloaders, video unloaders, and the like.

Using the system 500, the negotiable instrument 100 may become a commodity akin to a stock which is publicly- or privately-traded, valued and backed by physical precious metals held in reserve by an originator 708 of the negotiable instrument (i.e., technology provider).

The system 500 includes a processor 502, memory 504 and a webserver 506. The processor 502, generally, can receive, process, analyze, manipulate, store, and transmit data between the originator 708 and nodes 604. In this way, the system 500 may include one or more processors 502 that execute instructions on a computer-readable medium, such as a central processing unit that cause the one or more processors 502 to run the modules.

Typically, the server 506 comprises one or more central processing units executing software and/or firmware to control and manage the other components within the system 500. In one embodiment, the server 506 comprises hardware and/or software more commonly referred to as a Multiple Virtual Storage (MVS), OS/390, zSeries/Operating System (z/OS), UNIX, Linux, or Windows.

The server 506 may comprise a server cluster with firewalls, load balancer, and database servers having Apache® and/or other software applications well-known to those of skill in the art. The server 506, in the shown embodiment, comprises a database management system (DBMS) or relational database management system (RDBMS), such as Oracle, MySQL, SQL, FireBird, IBM DB2®, or the like.

The encoder module 508 encrypts the blockchain representative of a predetermined quantity of precious metals held in reserve within the blockchain or distributed ledger 100, including the genesis node 602. Nodes 604 may internal or external to the system 500, which is under the control of the originator 708. A validation protocol may be executed by the nodes 604 and a serving module 510 serves the content from a bearer 202.

The exchange module receives an electronic negotiable instrument into an electronic wallet of the originator 708 who then exchanges physical precious metals for the electronic negotiable instrument 706.

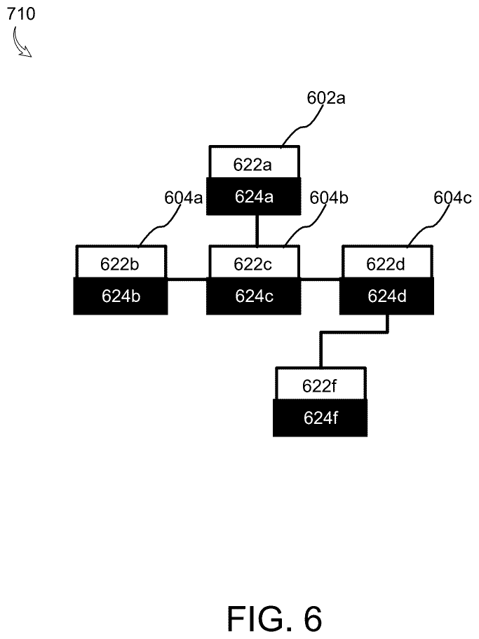

FIG. 6 is a data entity diagram illustrating a specie negotiable instrument 710 in accordance with the present invention.

The blockchain 710 may define the quantity 622 of precious metal to which a bearer of the electronic negotiable instrument (i.e, specie negotiable instrument) is entitled, as well as the type of metal 624.

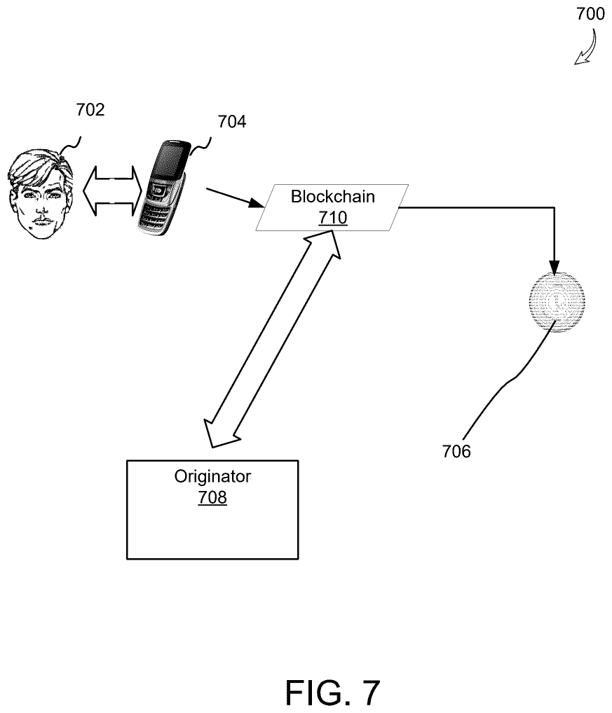

FIG. 7 is a data entity diagram illustrating the steps of a method of creating a specie negotiable instrument in accordance with the present invention.

A bearer 702 using a data-processing device (DPD) 704 to exchange an electronic negotiable instrument 706 a predetermined quantity of precious metal. The electronic negotiable instrument may be embodied within a blockchain 710 created by an originator 708.

The blockchain 710 may be public ledger or private ledger. In the shown embodiment, the blockchain 710 is a public ledger using tangle or hashgraph technology. The blockchain 710 comprises multiple records stored in a database which is not centralized in the shown embodiment, but rather spread across different participants (or nodes 604).

A blockchain structure allows for global interchange of data relating to a plurality of unrelated transactions to be confirmed at once. While blocks make sense for public blockchain systems like Bitcoin, this logic does not apply to trusted distributed ledger networks used publicly or privately. A “block” is a bundle of transaction data. Most closely associated with Bitcoin, a blockchain structure connects blocks such that each block includes the hash value of the previous block, thereby forming a chain of valid transactions. In trusted, private distributed ledger networks, it is not necessary to group unrelated transactions into blocks which are shared with miners and unrelated parties.

The methodology taught and provided in this disclosure may be realized using a centralized or decentralized blockchain which is exchangeable in whole or in part for precious metal.

The blockchain 710 achieves a consensus without having to validate across an entire blockchain.

The blockchain 710 is spread across multiple nodes 604 with each node independently replicating and saving an identical copy of the blockchain 710, eliminating the needs for a central authority. Records are not communicated to various nodes 604 by a central authority, but independently constructed and held by every node 604. When records are shared between nodes 604, and the nodes 604 reach a consensus using a consensus protocol (or “proof-of-work” protocol) on the accuracy of a record.

The records, or transactions, are encrypted using a cryptographic hash function. The collective records may be rendered, or encoded, as a Merkle tree.

A bearer 202 initiates the transaction with the originator 708. In various embodiments, the originator exchanges physical precious metal for the electronic negotiable instrument.

Prospective owners of the electronic negotiable instrument 706 may also be given to a cryptographic digital asset by the originator 708.

Functionally, a decentralized computing system such as that shown in FIG. 7 DPD 704.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Many of the functional units described in this specification have been labeled as modules, in order to more particularly emphasize their implementation independence. A module may comprise utilitarian objects of any kind, including mechanical structures or devices, electrical devices, electromechanical devices, optical devices, analog electronics, digital electronics, and so forth. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more computer readable media.

Reference to a computer readable medium may take any form capable of storing machine-readable instructions on a digital processing apparatus. A computer readable medium may be embodied by a transmission line, a compact disk, digital-video disk, a magnetic tape, a Bernoulli drive, a magnetic disk, a punch card, flash memory, integrated circuits, or other digital processing apparatus memory device.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A specie negotiable instrument comprising:
a flexible backing material;
a plurality of markings layered upon the flexible backing material, the markings comprising:
a predetermined quantity of a precious metal,
a serial number,
a first denomination indicator indicating a total predetermined weight of a first precious metal incorporated into the markings,
a precious metal identifier,
a seal indicating a source of origin of the physical negotiable instrument,
a legend reading one or more of the following in whole or in part, “exchangeable for money”, “payable on demand”, “unconditional promise”, “to pay a fixed amount of money to the bearer, “legal tender to bearer upon demand.”

2. The specie negotiable instrument of claim 1, wherein the flexible backing material comprises a foil comprising a precious metal.

3. The specie negotiable instrument of claim 1, wherein one or more of the markings layered upon the flexible backing material comprise woven fibers of precious metals.

4. The specie negotiable instrument of claim 1, wherein the markings layered upon the flexible backing material are bonded thereto.

5. The specie negotiable instrument of claim 1, wherein the flexible backing material comprises a polymeric sheet.

6. The specie negotiable instrument of claim 1, wherein the predetermined quantity of precious metal comprises one of the following fractions of a troy ounce: 1/4000, 1/5000, 1/20, 1/40, 1/100, ¼, 1/200, 1/100, 1/10 and ½.

7. The specie negotiable instrument of claim 1, further comprising a second denomination indicator indicating a total predetermined weight of a second precious metal incorporated into the markings.

8. The specie negotiable instrument of claim 1, wherein the physical negotiable instrument is produced for recognition by a government as a legal tender.

9. The specie negotiable instrument of claim 1, wherein both a reverse surface and an obverse surface of the physical negotiable instrument are clear-coated with one of a flexible polymeric, silicone or urethane layer, enveloping the markings between clear-coated surfaces.
